(19) United States
(12) Patent Application Publication
(10) Pub. No.: US 2002/0139094 A1
(43) Pub. Date: Oct. 3, 2002

(54) Bridle bit

(76) Inventor: Magnus Olafur Jonsson, Stykkisholmur (IS)

Correspondence Address: JACOBSON HOLMAN PLLC, 400 SEVENTH STREET N.W., SUITE 600, WASHINGTON, DC, 20004, US

(21) Appl. No.: 09/567,427

(22) Filed: May 10, 2000

(30) Foreign Application Priority Data
Sep. 23, 1999 (IS) 5192

(51) Int. Cl. B68B 1/06

(52) U.S. Cl. 54/7

(57) ABSTRACT

The invention relates to the restriction of the angular displacement of a bit for animals so that it is comfortable in the animal's mouth and facilitates training and control. The bit consists of a central section, end sections and bridle-irons, which ar joined by means of ball-joints of such a design and size as to restrict the angular displacement of the bit. The bit according to this invention is intended to have restricted angular displacement in the animal's month so as to prevent it from rising too high and injuring the animal's palate. It is also intended to avoid excessive pinching of the corners of the animal's mouth and its jaw, and to restrict the resistance of the ball joints so that it is easy for the animal to move its tongue and teeth relative to the bit without encountering resistance, and to prevent the animal from passing its tongue over the bit. The restriction of the angular displacement of the bit is based on the thickness of the ball-neck and the size of the socket apertures in the ball-joints in the bit.

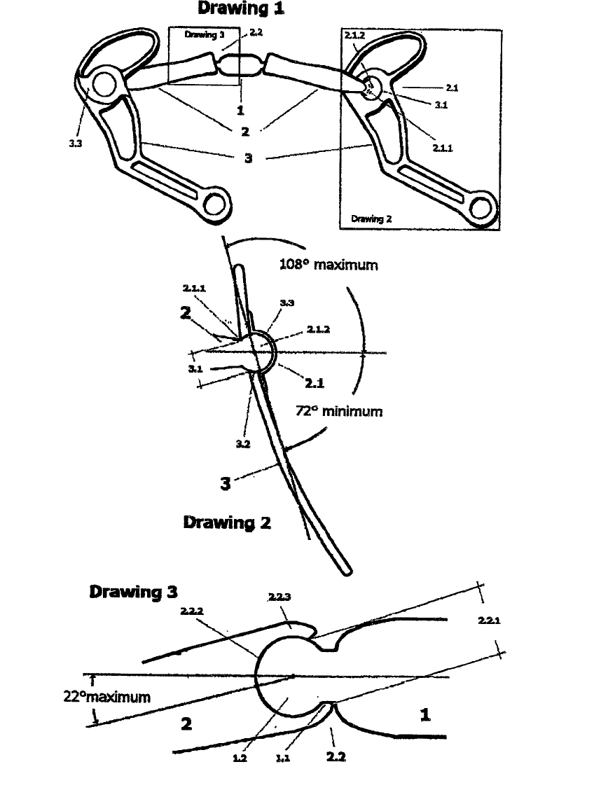

The invention concerns the restriction of the angular displacement of a bridle bit so that it sits comfortably in the animal's mouth and facilitates training and control. The bit consists of a central section, end sections and bridle-irons which are connected by ball-and socket joints of a shape and size such as to restrict the angular displacement of the bit.

There are various problems associated with the training and control of animals. Horses are good examples of such animals and the following problems can be mentioned:

The horse rushes ahead with its head in horizontal position.

Problems with the tongue, with the horse placing its tongue over the bit.

Uncontrollability, with the horse not responding to attempts to control it but simply rushing on ahead.

The present invention is intended to reduce these problems and thus shorten the time required for training animals and to make them more responsive to control, and also to improve the treatment of the animals.

Ball-jointed bits exist, with or without central sections, with ball-joints in the center or on the bridle-irons. irons. However, these bits do not restricted the angular displacement of the bits in the way the present invention is intended to do; the method involved in the present invention is explained in the following comparison with the patents and patent applications the are known.

German Patent No. 62,902 employs either a fixed joint or a ball-joint in the centre, with ball-joints to the bridle-irons. The aim of this design is to permit the bit to adjust to the tension put on the reins in order to control the animal. The design is clearly not designed to ensure maximum flexibility of the bit in the animal's mouth, since the bit consists either of a single non-flexible section or of two sections connected with eyes. The inclusion of a ball-joint or a hole on the outer end of the bit to connect the bridle-iron or ring to the bit is of no significance in restricting the angular displacement of the bit.

U.S. Pat. No. 1,091,683 is base on a central section with a fixed plate. The central section is joined to the end section with balls and socket. This patent differs from the present invention in that the ball joining and the aim of the patented invention are not related to the restriction of the angular displacement of the bit, and as the patented invention is described, they have no effect towards that purpose.

U.S. Pat. No. 4,005,564 is based on a central section with a toothed wheel, with connections to the end sections that are similar to those in U.S. Pat. No. 1,091,683. Nowhere in U.S. Pat. No. 4,005,564 is it stated that the ball-jointing is intended to restrict the angular displacement of the bit, which the present invention is intended to do. Instead, the U.S. patent concentrates on the toothed wheel in the central section and the connection of the sockets to the end sections of the bit.

British Patent No. 2,167,637 A involves a ball-jointed bit in which a wire is intended to restrict the angular displacement of the bit only when the reins are pulled. All other things being equal, this design does not restrict the angular displacement of the bit, and does not do so at all within the limits attained by the solution embodied in the present invention, and the two an completely different in design.

The features that distinguish the present invention and set it apart from known patents and patent applications arc that thc bit is horizontally ball-jointed to the bridle-irons and has a ball-joint in the centre; all of the balls lie in sockets or socket rims with restricted angular displacement so that the bit will not rise too high and injure bit animal's palate. The invention is intended to avoid excessive pinching of the corner of the mouth and the jaw, to limit the resistance of the ball-joints so that it is easy for the animal to move its tongue and teeth relative the bit without encountering obstruction, and to prevent the animal front passing its tongue over the bit,

The aim of the present invention is to make available bridle-and-bit equipment for casier training and control of animals which need to use bridles, and also to increase their well-being in their dealings with human beings. Better treatment of animals makes for quicker training and raises the value of the animals both for use and for commerce.

These aims are achieved with the present invention as described in the defining parts of Patent claims 1-5.

The invention is described with reference to the accompanying drawings, in which

Drawing 1 shows the ball-jointed parts of the bit: the central section 1, the end sections 2 and the bridle-irons 3.

Drawing 2 shows individual parts of the ball-joint 2.1 of the bridle-irons 3 to the end sections 2 and the maximum and minimum angular displacement between the bridle-irons 3 and the end sections 2, which is restricted by the neck or the ball 2.1.1 on the outer end of the end section 2, the circumference of the socket aperture 3.1 on the bridle-irons and the socket 3.2 on the bridle-irons 3, in which the terminal ball 2.1.2 on the end section 2 is fixed in the socket 3.2 by means of the spherical segment boss 33.

Drawing 3 shows individual parts of the ball-joint 2.2 between the central section i and the inner end of the end section 2, in witch the ball-neck 1.1 restricts the angular displacement together with the socket aperture 2.2.1, the socket 2,2.2., the socket rim 2.2.3 on the inner end of the end section and the ball 1.2 on the end of the central section 1.

The invention described above is not restricted to the embodiment described here, which is submitted as an illustration of the principal idea; on the contrary it can be embodied in more ways without departing from the idea described here.

Patent claims:

1. A bit consisting of up to five ball-jointed sections characterised by the shapes of the ball-joints restricting the maximum angular displacement of the sections of the bit.

2. A bit according to claim 1 with a neck and ball on the end of one section and a socket with a socket aperture on the end another section which close around the ball of the next section by means of a socket rim and characterised by the aperture of the socket and the thickness of the neck restricting the angle of displacement between the central section and the end section to a maximum of 22° from the central line of the central section, the angle being subtended at the center of the ball.

3. A bit according to claim 1 with a ball at the outer end of each end motion of the bit which is connected to the bridle-iron though a socket aperture and fastened with a boss and characterised by bridle-irons with socket rims on the edge of a socket against which the inner part of the ball lies and a fixed boss with a spherical segment in its centre which is attached to the outside of the bridle-iron so that it surrounds the outer end of the ball and holds it in the socket.

4 A bit according to claims 1 and 3 and characterised by the size of the aperture on the bridle-irons and the thickness of the neck joining the outer end of the end section to the ball at the end restricting the angle between the central line of the end section and the bridle iron to a minimum of 72° and a maximum of 108°.

5. A bit according to claims 1 to 4 and characterised by ball-joins which connect the sections of the bit, on the one hand, and the bit and the bridle-irons, on the other, in which all sections of the bit can rotate with respect to cash other and the sections of the bit can rotate in the bridle-irons, without the maximum angle between the central section and the end sections, on the one hands and the end sections and the bridle-irons, on the other, exceeding specific limits.
